(19) United States
(12) Patent Application Publication
(10) Pub. No.: US 2022/0396292 A1
(43) Pub. Date: Dec. 15, 2022

(54) A METHOD AND SYSTEM FOR CONTROLLING A USER-INITIATED VEHICLE-OPERATION-COMMAND

(71) Applicant: Ford Global Technologies, LLC, Dearborn, MI (US)

(72) Inventors: Ahmed Benmimoun, Aachen/NRW (DE); Chenhao Ma, Canton, MI (US); Tony Tae-Jin Pak, Garden City, MI (US); Hamid M. Golgiri, Livonia, MI (US)

(73) Assignee: Ford Global Technologies, LLC, Dearborn, MI (US)

(21) Appl. No.: 17/748,132

(22) Filed: May 19, 2022

(30) Foreign Application Priority Data
Jun. 15, 2021 (EP) 21179476.3

(51) Int. Cl. B60W 60/00; B60W 50/12; G07C 9/00

(52) U.S. Cl. CPC B60W 60/00188; B60W 50/12; G07C 9/00309; B60W 2554/4041

(57) ABSTRACT

A method for controlling a user-initiated vehicle-operation-command, the user of the vehicle being located external to the vehicle during an autonomous driving or parking operation of the vehicle, is provided wherein the vehicle-operation-command is a cancellation or stop command of the autonomous driving or parking operation. A system equipped to perform the method and to a vehicle including the system is also provided. The method and apparatus enhance the security-level of autonomous driving and parking operations.

### CROSS-REFERENCE TO RELATED APPLICATION

This patent application claims priority to European Application No. EP 21179476.3 filed Jun. 15, 2021, which is hereby incorporated by reference in its entirety.

### BACKGROUND

The present disclosure relates to a method for controlling a user-initiated vehicle-operation-command during an autonomous driving or parking operation of the vehicle, to a system equipped for performing the method, and a vehicle equipped with the system.

### SUMMARY

The present disclosure makes use of known autonomous driver-assistance systems (ADAS) as used for autonomously driving a vehicle. Such advanced driver-assistance systems in vehicles may include Valet Parking Assistance (VaPA) to provide fully automated steering and maneuvering when parking, for example within a parking lot or parking structure. Such systems use automated vehicle controls such as GPS (Global Positioning System) or on-board sensors along with camera, lidar, radar proximity, and ultrasonic sensors, to navigate, identify valid parking slots, and park the vehicle (“drop-off” maneuver). The vehicle is also able to autonomously drive the parked vehicle from a parking slot to a specified pickup location (“summon” maneuver) upon request by the user. Within a summon maneuver, the vehicle drives along a specified route or distance. Consequently, the summon maneuver is an operation during which the vehicle drives (driving operation). The aforementioned “drop-off” maneuver more relates to a parking operation. Thus, as used herein, the term “driving operation” is synonymous with the term “drop-off maneuver” and the term “parking operation” is synonymous for the term “summon maneuver”.

Autonomous driver-assistance systems (ADAS) require information about the area where they are to be mapped for the vehicle to plan a route for the drop-off and summon maneuver. This digital map of the area, for example a parking lot or parking structure, could be very simple and consist only of a description of the drivable sections, or more complex such as high-definition maps with additional attributes such as signs, lane widths, and the like. In most cases, the ADAS or VaPA has to consider an actual traffic situation in the area of use, for example the parking lot or parking structure.

Once an autonomous driving or parking operation is in progress, there are several situations where the user might want to stop the vehicle (e.g., forgot to take out something from the vehicle before dropping off the vehicle, change of plans after starting a summon maneuver, etc.). This intention to stop/cancel a driving/parking operation of the vehicle by the user is specified as user-initiated vehicle-operation-command in the following. However, it is undesired to allow the user to stop the vehicle during an automated maneuver as it could lead to inconvenience for other traffic participants (e.g., blocking traffic behind the vehicle, stopping in an intersection, etc.) without the user being aware of this because he is located at a different location. Additionally, a user-initiated cancellation or stop command could—without an appropriate verification procedure—allow for misuse.

Methods according to example implementations of the present disclosure are capable of controlling a vehicle-operation-command during an autonomous driving or parking operation of the vehicle in a manner that enhances the security-level of autonomous driving and parking operations and overcomes or at least mitigates the shortcomings of the prior art, or that at least provides a user with a convenient alternative.

Devices constructed according to example implementations of the present disclosure are capable of providing a system and a vehicle that overcome or at least mitigate the shortcomings of the prior art, or that at least provide a user with a convenient alternative.

According to one or more implementations, a method for controlling a user-initiated vehicle-operation-command is provided, the user of the vehicle being located external to the vehicle during an autonomous driving or parking operation of the vehicle, wherein the vehicle-operation-command is a cancellation or stop command of the autonomous driving or parking operation. The user-initiated vehicle-operation-command is verified based on a first, a second, and/or a third verification-criterion. The first verification-criterion relates to an actual distance between the user and the vehicle, the second verification-criterion relates to a direction of movement of the user relative to the vehicle, and the third verification-criterion relates to the traffic and/or parking situation in the vicinity of the vehicle. For each of the verification-criteria at least a first threshold value or threshold condition is pre-defined. The verification is performed by comparing a measured or otherwise determined value or condition relating to the first, second, and/or third verification-criterion with the respective at least first threshold value or threshold condition. In case that the measured or otherwise determined value or condition relating to the first, second, and/or third verification-criterion exceeds the respective at least first threshold value or threshold condition, the cancellation or stop command of the autonomous driving or parking operation is denied, and in case that the measured or otherwise determined value or condition relating to the first, second, and/or third verification-criterion is lower than the respective at least first threshold value or threshold condition, the cancellation or stop command of the autonomous driving or parking operation is accepted.

As mentioned before, the verification is performed by comparing a measured or otherwise determined value or condition relating to the first, second, and/or third verification-criterion. The comparison can also be performed by comparing several measured or otherwise determined values or conditions. As used herein, measuring a “value” means to perform a measurement of any kind to determine a measurement value (which can e.g., be a value representing the distance between the user and the vehicle). However, besides measuring, a value can also otherwise be determined, e.g., by evaluating data (such as position or GPS data of the vehicle and the user). A movement direction of the user may also be understood as condition.

The verification is performed on suitable means for verification, e.g., a computer or a calculation unit (e.g., a microcontroller). The means for verification may be part of a control unit of the vehicle. The means for verification might also be located external to the vehicle, e.g., on a server. The server might then wirelessly be connected (signal and data connection) to a control unit of the vehicle, e.g., by way of a mobile internet connection. The verification criteria can be pre-defined and updated from time to time. As mentioned above, the first verification-criterion relates to an actual distance between the user and the vehicle. For the distance between the user and the vehicle one or more threshold values can be defined, each of them being associated with a pre-defined consequence (when being fulfilled). The threshold values could e.g., be 5 m and 25 m. The second verification criterion relates to a direction of movement of the user relative to the vehicle. A related threshold condition may be a direction of movement toward or away from the vehicle. The direction of movement, in particular the threshold condition, can also relate to a user crossing a path of the vehicle. The third verification-criterion relates to the traffic and/or parking situation in the vicinity of the vehicle. A related threshold condition or value could be directed to the amount of traffic participants in the vicinity of the vehicle, the amount of blocked parking slots, the direction of movement traffic participants in the vicinity of the vehicle, or the like.

Depending on the nature of the user-initiated vehicle-operation-command, the latter may be verified based on the first verification-criterion only, the second verification-criterion only, the third verification-criterion only, on a combination of the first and a second verification-criterion, on a combination of the first and the third verification-criterion, on a combination of the second and the third verification-criterion, or on a combination of the first, second and the third verification-criterion. Each of the verification criteria may include one or more sub-verification criteria or conditions.

As used herein, the term “traffic situation” may relate to a number of vehicles, motorcycles, pedestrians, bicycles, or other driving units (e.g., e-Scooter) driving in the vicinity of the vehicle, including their driving direction, driving speed, and driving scheme. The term “parking situation” may relate to the number of vehicles, bicycles, motorcycles, or other driving units parking in the vicinity of the vehicle.

The “direction of movement” of the user relative to the vehicle may be simplified in terms of the user moving toward the vehicle or the user moving away from the vehicle. Also, a steady state movement (e.g., parallel) relative to the vehicle may be present. Additionally, a user-behaviour relating to an interception of a path of the vehicle might be understood as “direction of movement”.

According to one or more implementations of the method, the autonomous parking maneuver may be a drop-off maneuver, or wherein the autonomous driving maneuver may be a summon maneuver. As defined before, a “drop-off” maneuver relates to a parking operation. A “summon maneuver” relates to an operation, where the vehicle autonomously drives from a parking slot to a specified pickup location.

According to one or more implementations of the method, the distance between the user and the vehicle may be determined based on an actual position of the user and the vehicle, and wherein the actual position of the user and the vehicle may be determined by using GPS data. Specifically, the distance between the user and the vehicle can be determined by comparing a current (actual) position of the vehicle and the user when the positions can be related with a distance (e.g., given in meter). The distance can be determined from calibrated maps, being correlated with actual GPS data (of the vehicle and the user). The actual position of the vehicle and the user may relate to mean position values of the vehicle or user over a given time-period. The position of the vehicle may be determined by a GPS system which is integrate in the vehicle. Also, an external GPS system installed in the vehicle may be employed. The position of the user may be determined by a GPS system included in an electronic handheld device (e.g., a smartphone, a tablet computer, a smartwatch, a wearable or the like).

According to one or more implementations of the method, the distance between the user and the vehicle may be determined based on key-fob ranging or by using on-board sensors of the vehicle. On board sensors may be sensors along with camera, lidar, radar, proximity and ultrasonic sensors. Any type of optical or electromagnetic sensor may be employed as long being configured to determine the distance between the user and the vehicle. The distance may be determined based on using one or more of the aforementioned sensors. The vehicle may comprise one or more of said sensors. The sensors may be located at different positions of the vehicle (the frontside, the rear side etc.). The sensors may directly track the body of the user, alternatively they may track a target of the user, e.g., by exchanging data or signals with an electronic handheld device of the user.

According to one or more implementations of the method, the direction of movement between the user and the vehicle may be determined based on permanently monitored position data of the user and the vehicle. By permanently monitoring the position of the user and the vehicle, a change in their relative position may be used to analyse if the user moves towards the vehicle (the distance between vehicle and user is reduced) or if the user moves away from the vehicle (the distance between vehicle and user is increased). Also, an interception of a vehicle path by the user can be determined by the mentioned procedure. Additionally, a potential movement of the vehicle also must be considered.

According to one or more implementations of the method, the traffic and/or parking situation may be permanently monitored, preferably by using traffic data, GPS data, and/or data measured with on-board-sensors of the vehicle. The vehicle may comprise a communication unit which is configured to wirelessly receive actual traffic information (traffic data) over a wireless (mobile) internet connection. The traffic data may be included in an on-board navigation system and thus be considered in a control unit (employing the verification). The communication unit may be (wirelessly or by wire) connected with the control unit such that a data- and signal exchange between the communication unit and the control unit. The communication unit may also be an external unit installed in the vehicle. GPS data of the vehicle and other traffic participants (vehicles, pedestrians, bicycles, motorcycles, or other driving units) can be provided by GPS units of the traffic participants which might be transmitted to a central system (e.g., a server) via the internet. The central system may combine all received GPS data of the traffic participants and provide said data to the control unit of the vehicle (via the communication unit). The traffic situation in the close vicinity of the vehicle may also well be monitored by using said on-board-sensors of the vehicle. All the mentioned options of monitoring the traffic and/or parking situation may be combined. A combined analysis may be performed in the control unit of the vehicle.

According to one or more implementations of the method, the user-initiated vehicle-operation-command may be wirelessly transmitted from an electronic handheld device, preferably a smartphone, to a control unit of the vehicle. The user may initiate the command via a smartphone application software (App), the App being configured to interact with the control unit of the vehicle. The electronic handheld device may be wirelessly connected with a communication unit of the vehicle (the communication unit itself being connected with the control unit) based on a short-range, mid-range, or long-range wireless connection. The connection may be employed via any possible communication standard. A possible connection may be employed via Bluetooth or a mobile internet connection.

According to one or more implementations of the method, the user-initiated vehicle-operation-command may be wirelessly transmitted from a wireless key to a control unit of the vehicle. Most of today's modern vehicles can be opened and locked by way of wireless keys. Within an autonomous driving or parking operation, a user might use such a key (e.g., by way of actuating the opening button) with the intention to open the car or stop the vehicle. The method may evaluate if the command (given by actuating the key) was intended or not intended by the user.

According to one or more implementations of the method, the user-initiated vehicle-operation-command relates to a manual opening attempt of a vehicle door or vehicle trunk by the user. In certain situations, the user may quickly approach the vehicle (the vehicle performing an autonomous driving or parking operation) to open the door or the trunk, e.g., in case the user has forgotten something in the vehicle etc. In case a door or the trunk of the vehicle is opened, the opening attempt can be detected by dedicated electronics or sensors and transferred to the control unit. The control unit evaluates (verifies) the user command and eventually stops the vehicle (cancels the autonomous parking or driving operation).

According to one or more implementations of the method, the user-initiated vehicle-operation-command relates to a movement sequence of the user indicating an intention of the user to cancel/stop the autonomous driving or parking operation, wherein the movement sequence is determined based on permanently monitored position data of the user and the vehicle or based on data detected with on-board sensors of the vehicle. For determining a movement sequence of the user, the position of the user must be tracked over a certain time interval. A movement sequence of the user can either be based on data being associated to a relative movement between the user and the vehicle or based on data being associated with a change of the position of the user (e.g., on a map).

According to one or more implementations of the method, in a case that the cancellation or stop command of the autonomous driving or parking operation is accepted, the vehicle stops with a smooth braking procedure. An abrupt braking procedure could be undesirable for the user or other traffic participants.

According to one or more implementations of the method, in a case that the cancellation or stop command of the autonomous driving or parking operation is accepted, it is evaluated whether the vehicle should be immediately stopped, or the vehicle should be stopped at the next possible location.

The vehicle may be immediately stopped if the traffic or parking situation allows. If the traffic or parking situation does not allow an immediate stop, the stop may be conducted at the next possible location (e.g., a free parking slot).

According to one or more implementations of the method, after the vehicle is stopped, the vehicle may wait for pre-defined time-period to enable vehicle access for the user, and wherein in a case that the user does not enter the vehicle within said pre-defined time-period, the vehicle continues the autonomous driving or parking operation.

According to one or more implementations of the present disclosure, a system for performing the method includes a parking or driving unit configured to perform the autonomous driving or parking operation, a control unit positioned in vehicle, wherein the control unit is configured to receive or determine the user-initiated vehicle-operation-command, and perform the verification, wherein the parking or driving unit and the control unit are configured to interact with each other in terms of exchanging electronic signals and data.

The driving unit and the control unit may be part of an internal board control system of the vehicle. The driving unit and the control unit may be connected to a communication unit of the vehicle, the communication unit being configured to wirelessly transmit and receive data to external servers, mobile devices etc via the internet.

Additionally, the system may comprise a unit for receiving and/or determining an (actual) distance between the user and the vehicle. Said unit may be configured to determine the walking/driving direction of the user/the vehicle with respect to each other. Moreover, the system may comprise a unit for receiving and/or determining nearby courteous stopping locations of the vehicle.

It is to be emphasized, that the system may comprise dedicated units or means for performing any of the method steps described above.

According to one or more implementations of the present disclosure, there is provided a vehicle equipped with said system, wherein the vehicle comprises a GPS system and/or at least one on-board sensor.

### SUMMARY OF THE DRAWINGS

The present disclosure will now be described in more detail with reference to the appended figures. In the figures:

FIG. 1 shows the flow of the method according to a first implementation.

FIG. 2 shows the flow of the method according to a second implementation.

FIG. 3 shows the flow of the method according to a third implementation.

FIG. 4 shows the flow of the method according to a fourth implementation.

FIG. 5 shows an implementation of a system to perform the method.

### DETAILED DESCRIPTION

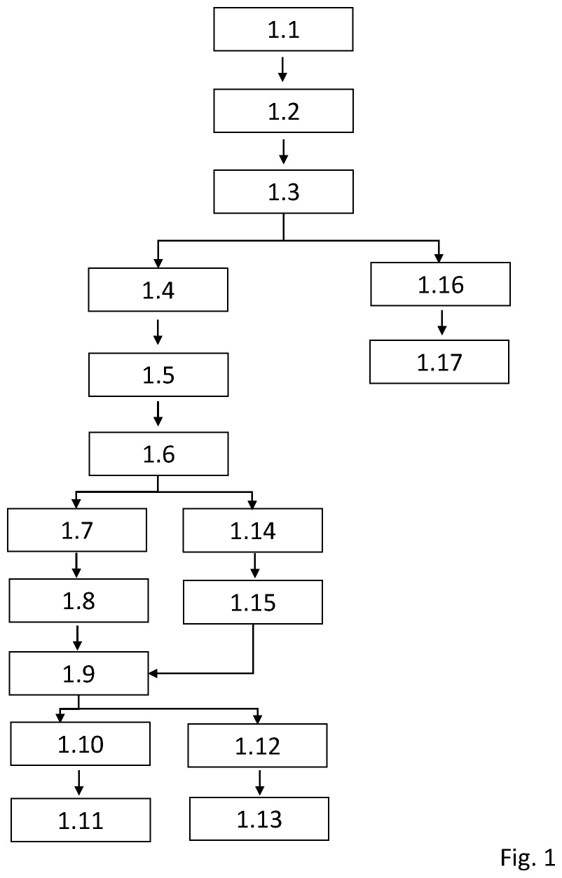

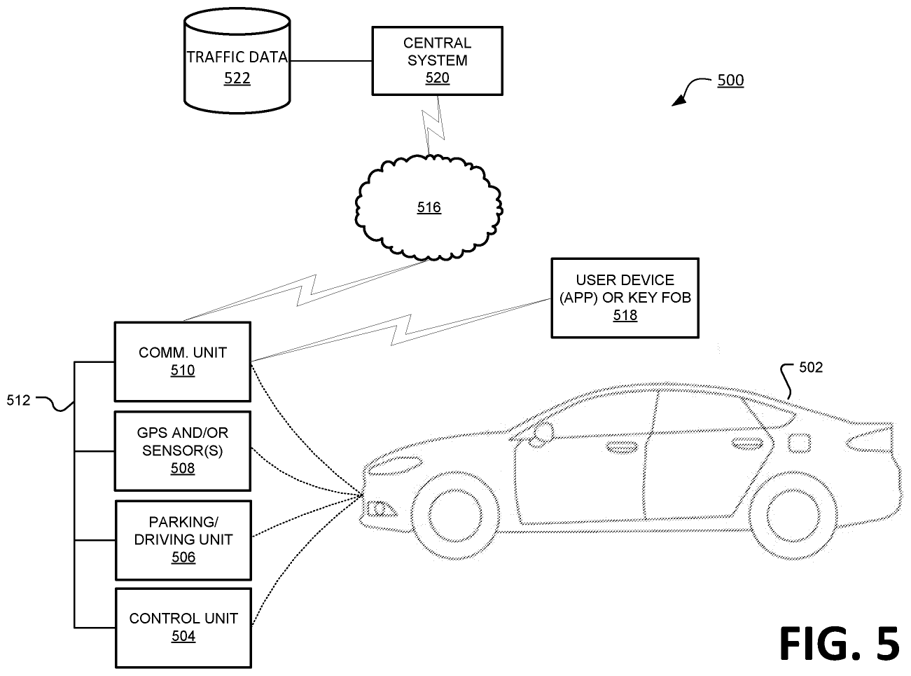

Turning to FIGS. 1 and 5, the flow chart describes the method with respect to an example where the user requests a cancellation/stop (user-initiated vehicle-operation-command) of a drop-off maneuver via an electronic handheld user device 518 (e.g., a smartphone). A cancellation/stop is only possible when the user is close to the vehicle 502. The stopping position is calculated based on how fast the user can reach the vehicle 502. The distance between the user and the vehicle 502 (relating to the first verification-criterion) can be determined by using the GPS location of the electronic handheld user device 518, key fob 518 ranging, or other suitable methods. Also, on-board sensors 508 might be used to determine the distance between user and vehicle 502. In a first step 1.1 the drop-off maneuver of the vehicle 502 is started. In case that a user wants to cancel/stop the drop-off maneuver (step 1.2), in step 1.3 it is verified if the user is located within a specified distance (providing a first threshold value or threshold condition of the first verification-criterion) relative to the vehicle. If the user is not located within the specified distance relative to the vehicle 502 (step 1.16), the cancellation/stop option is not available to the user on the electronic handheld user device 518 (e.g., in an appropriate application software, App). Instead, an additional option is offered to the user, with which he can request the vehicle to return to the drop-off location, if desired. If the user is located within the specified distance from the vehicle 502 (step 1.4), in a follow-up step 1.5 the cancellation/stop option is made available on the electronic handheld user device 518 (e.g., the App). The user can then initiate a cancelling/stop of the drop-off maneuver in the App. It is then (step 1.6) verified if the user is located very close (e.g., <5 m) relative to the vehicle 502. If the user is not located very close to the vehicle 502 (step 1.14), the vehicle stops at the next suitable location (not blocking other traffic) and informs the user about its location (e.g., via the App), step 1.15. If the user is located very close to the vehicle 502 (step 1.7), the vehicle 502 stops via a smooth braking procedure and continues to monitor the location of the user (step 1.8). It is verified if the user is moving away from the vehicle 502 or if a certain time-period is passed without opening any door (step 1.9). Said step 1.9 can also be performed following step 1.15. In case that the user moves away from the vehicle 502 or the time-period is passed (step 1.10), the vehicle 502 continues the drop-off maneuver. The user is then informed on his electronic handheld user device 518 (step. 1.11). In case that the user does not move away from the vehicle 502 or the time-period is not passed (step 1.12), the vehicle 502 waits for the user to access the vehicle 502 and then continues the drop-off maneuver after the user has finished his action and closed the doors (or the trunk), step. 1.13.

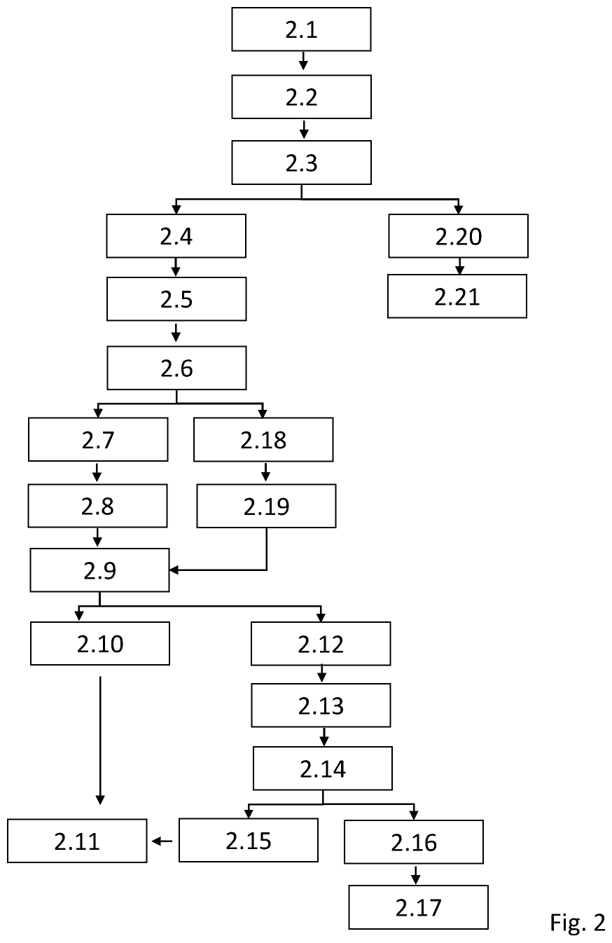

Turning to FIGS. 2 and 5, the flow chart describes the method with respect to an example where the user requests a cancellation/stop (user-initiated vehicle-operation-command) of a summon maneuver via an electronic handheld user device 518 (e.g., a smartphone). A cancellation/stop of the maneuver is only possible when the user is close to the vehicle 502 and the stopping position is based on how fast the user can reach the vehicle 502. Otherwise, the vehicle 502 will cancel the summon maneuver and park in the next available parking slot. Here, the vehicle 502 takes surrounding traffic into account (third verification-criterion) and if the user acts according to his request (approaching the vehicle in a defined time). In a first step 2.1 the summon maneuver of the vehicle 502 is started. In case that a user wants to cancel/stop the summon maneuver (step 2.2), in step 2.3 it is verified if the user is located within a specified distance (providing a first threshold value or threshold condition of the first verification-criterion) relative to the vehicle 502. If the user is not located within the specified distance relative to the vehicle 502 (step 2.20), the cancellation/stop option is not available to the user on the electronic handheld user device 518 (e.g., in an appropriate application software, App). Instead, the user can request the vehicle 502 to return to where it was previously parked or park itself at the next best parking slot, step 2.21. If the user is located within the specified distance from the vehicle 502 (step 2.4), providing a first threshold value or threshold condition of the first verification-criterion, in a follow-up step 2.5 the cancellation/stop option is made available on the electronic handheld user device 518 (e.g., the App). The user can then initiate a cancelling/stop of the summon maneuver in the App. It is then (step 2.6) verified if the user is located very close (e.g., <5 m) relative to the vehicle 502. If the user is not located very close to the vehicle 502 (step 2.18), the vehicle 502 stops at the next suitable location (not blocking other traffic) and informs the user about its location (e.g., via the App), step 2.19. If the user is located very close to the vehicle 502 (step 2.7), the vehicle 502 stops via a smooth braking procedure and continues to monitor the location of the user (step 2.8). It is verified if the user is moving away from the vehicle 502 or if a certain time-period is passed without opening any door (step 2.9). Said step 2.9 can also be performed following step 2.19. In case that the user moves away from the vehicle 502 or the time-period is passed (step 2.10), the vehicle 502 cancels the summon maneuver and looks for the next empty spot and parks in that spot. The user is informed about this procedure and the vehicle's location, step 2.11. In case that the user does not move away from the vehicle 502 or the time-period is not passed (step 2.12), the vehicle 502 waits for the user to access the vehicle 502, step 2.13. It is then checked if the user enters the vehicle within a defined time-period, step 2.14. If the user enters the vehicle 502 in the defined time-period (step 2.16), the autonomous operation of the vehicle 502 is terminated. Control is handed over to the user after authentication, step 2.17. If the user does not enter the vehicle 502 within the defined time-period (step 2.15), the method proceeds with step 2.11.

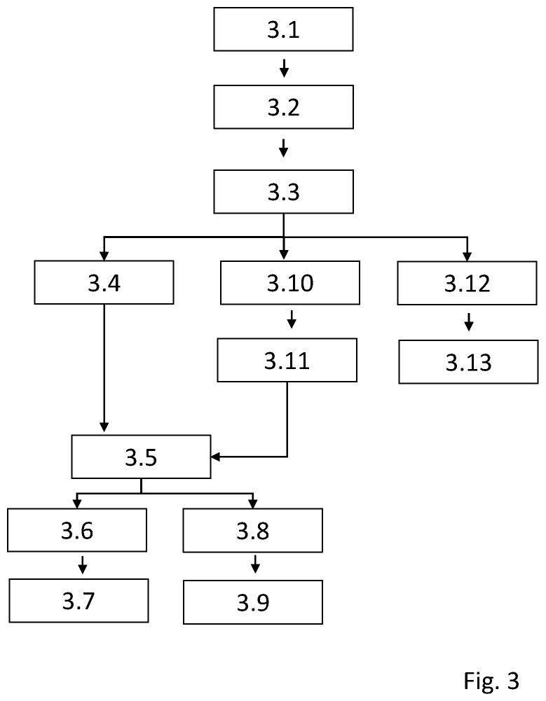

Turning to FIGS. 3 and 5, the flow chart describes the method with respect to an example where the user might try to stop the vehicle 502 during an ongoing autonomous parking/driving operation without a cancellation/stop request via an electronic handheld user device 518. The user could unlock the door or open the trunk which procedure could be considered as an indication that the user might want to cancel/stop the autonomous parking/driving operation/maneuver. However, this could also result from a user accidentally pressing the unlock/trunk open button on the key fob 518. To minimize the user accidentally cancelling/stopping the autonomous parking/driving operation/maneuver which could cause inconvenience to other traffic participants, the system continuously monitors the user behaviour and location and identifies if the user has the intention to approach the vehicle 502 to take over. It is also verified whether the user can reach the vehicle 502 on time to prevent blocking traffic participants. After starting an autonomous parking/driving maneuver (step 3.1), and a user initiating a vehicle-operation-command by pressing an opening button of the key fob 518 (step 3.2), the distance of the user to the vehicle 502 is determined, step 3.3. In case that the user is located far away from the vehicle 502 (e.g., not in line of sight), see step 3.12, the user command is ignored and classified as accidental. The vehicle 502 continues the maneuver, step 3.13. In case that the user is in a close distance to the vehicle 502 (e.g., <25 m, being in line of sight), step 3.10, the vehicle 502 stops at the next suitable location (not blocking other traffic participants) in step 3.11. In a case that the user is in a very close distance to the vehicle 502 (step. 3.4), e.g., <5 m, the vehicle 502 stops and waits for user's take over, step. 3.5. Said step 3.5 also follows to step 3.11. In step 3.6 a take over of the vehicle 502 by the user is detected. In step 3.7 the autonomous parking/driving maneuver is terminated. In a case that no take over of the vehicle 502 by the user is detected in a specified time-period (step 3.8), the trunk/doors is/are locked and the vehicle 502 resumes the autonomous maneuver, step 3.9.

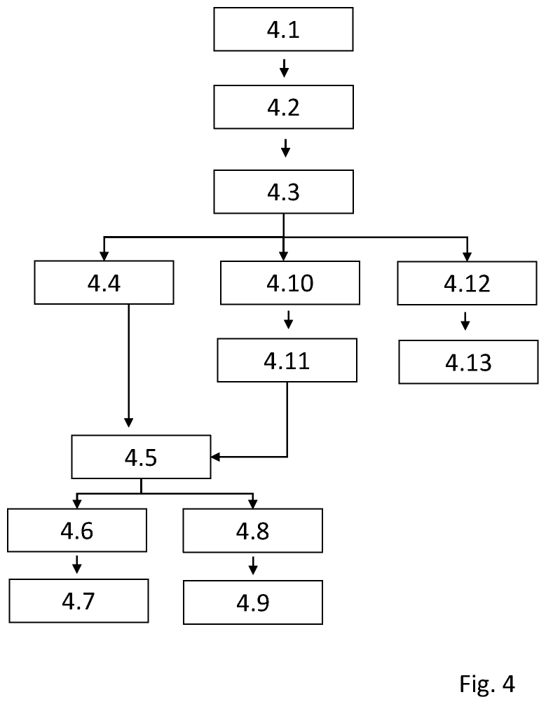

Turning to FIGS. 4 and 5, the flow chart describes the method with respect to an example where the user intends to stop the vehicle 502 and moves toward the vehicle 502 (second verification criterion). Within the method the location of the user relative to the vehicle 502 can continuously be monitored. If the user is moving toward the vehicle 502 or trying to intercept the vehicle 502 (e.g., running behind the vehicle 502 after drop-off) it can be determined if the user might want to approach the vehicle 502 without cancellation/stop command through a remote device (e.g., electronic handheld user device or key fob 518). If the user gets within a specified distance relative to the vehicle 502 (first verification-criterion), the vehicle 502 will stop. It is then checked if the user performs further actions (e.g., open the door, trunk etc.). If the user does not take further actions within a defined timeout period, or the user is getting further away from the vehicle 502, it will be assumed that the user does not want to cancel/stop the maneuver. The previous automatic maneuver is then resumed.

After starting an autonomous parking/driving maneuver (step 4.1), the position (location) of the user relative to the vehicle 502 is monitored (step 4.2). Then (step 4.3) the direction of movement is determined (second verification criterion), specifically it is determined if the user is moving toward the vehicle/the path of the vehicle 502 (e.g., running behind the vehicle 502 or intercepting the vehicle 502). To sum up, the direction of movement (as relating to the second verification criterion) can be determined. In case that the user is located far away from the vehicle 502 (e.g., not in line of sight), see step 4.12, the user command is ignored. The vehicle 502 continues the maneuver, step 4.13. In case that the user is in a close distance to the vehicle 502 (e.g., <25 m), in which distance the user is in line of sight relative to the vehicle 502, see step 4.10, the vehicle 502 stops at the next suitable location (not blocking other traffic participants) in step 4.11. In case that the user is in a very close distance to the vehicle 502 (step. 4.4), e.g., <5 m, the vehicle 502 stops and waits for user's take over, step. 4.5. Alternatively, in step 4.5 instead of waiting for taking over the vehicle 502, the vehicle 502 waits for further actions of the user (e.g., unlocking, grabbing door handle etc). Said step 4.5 also follows to step 4.11. In step 4.6 a taking over of the vehicle 502 by the user is detected. In step 4.7 the autonomous parking/driving maneuver is terminated. In case that no taking over of the vehicle 502 by the user is detected in a specified time-period, or the user is moving further away from the vehicle 502 (step 4.8), the vehicle 502 resumes the autonomous maneuver, step 4.9.

Turning to FIG. 5, a system 500 for performing the methods includes vehicle 502 with a parking or driving unit 506 configured to perform the autonomous driving or parking operation, a control unit 504 positioned in vehicle 502, wherein the control unit 504 is configured to receive or determine the user-initiated vehicle-operation-command, such as via communication unit 510, and perform the verification. The parking or driving unit 506 and the control unit 504 are configured to interact with each other in terms of exchanging electronic signals and data.

The driving unit 506 and the control unit 504 may be part of an internal board control system 512 of the vehicle 502. The driving unit 506 and the control unit 504 may be connected to a communication unit 510 of the vehicle, the communication unit 510 being configured to wirelessly transmit and receive data to external servers, such as central system 520, mobile devices, etc via the internet 516.

Additionally, the system 500 may comprise a unit with GPS or sensor(s) 508 for receiving and/or determining an (actual) distance between the user and the vehicle. Said unit may be configured to determine the walking/driving direction of the user/the vehicle 502 with respect to each other. Moreover, the system may comprise a unit for receiving and/or determining nearby courteous stopping locations of the vehicle based upon the GPS and/or sensor(s) 508. The system 500 may comprise dedicated processors, ASICS, units, or means for performing any of the method steps described above.

The traffic and/or parking situation may be permanently monitored, preferably by using traffic data 522, GPS 508 data, and/or data measured with on-board-sensors 508 of the vehicle 502. The vehicle 502 includes communication unit 510 which is configured to wirelessly receive actual traffic information (traffic data 522) over a wireless (mobile) internet connection. The traffic data 522 may alternately be included in an on-board navigation system and thus be considered in a control unit (employing the verification). The communication unit 510 may be (wirelessly or by wire) connected via 512 with the control unit 504 such that a data and signals are exchanged between the communication unit 510 and the control unit 504. The communication unit 510 may also be an external unit installed in the vehicle 502. GPS data of the vehicle 502 and other traffic participants (vehicles, pedestrians, bicycles, motorcycles, or other driving units) can be provided by GPS units of the traffic participants which might be transmitted to a central system 520 (e.g., a server) via the internet 516. The central system 520 may combine all received GPS data of the traffic participants and provide said data to the control unit 504 of the vehicle 502 (via the communication unit 510). The traffic situation in the close vicinity of the vehicle 502 may also well be monitored by using said on-board-sensors 508 of the vehicle 502. All the mentioned options of monitoring the traffic and/or parking situation may be combined. A combined analysis may be performed in the control unit 504 of the vehicle 502.

With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain implementations and should in no way be construed so as to limit the present disclosure.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1.-15. (canceled)

16. A method for controlling a user-initiated vehicle-operation command, the user of the vehicle being located external to the vehicle during an autonomous driving or parking operation of the vehicle, the method comprising:
receiving a cancellation or stop command of the autonomous driving or parking operation;
verifying the cancellation or stop command based on a first, a second and/or a third verification-criterion, wherein:
the first verification-criterion includes an actual distance between the user and the vehicle,
the second verification-criterion includes a direction of movement of the user relative to the vehicle, and
the third verification-criterion includes a traffic and/or parking situation in a vicinity of the vehicle,
wherein, for each of the first, second, and/or third verification-criteria, at least a first threshold value or threshold condition is pre-defined, and
wherein the verification is performed by comparing a measured or otherwise determined value or condition corresponding to the first, second, and/or third verification-criterion with the respective at least first threshold value or threshold condition;
denying the cancellation or stop command of the autonomous driving or parking operation when the measured or otherwise determined value or condition corresponding to the first, second, and/or third verification-criterion exceeds the respective at least first threshold value or threshold condition; and
accepting the cancellation or stop command of the autonomous driving or parking operation when the measured or otherwise determined value or condition corresponding to the first, second, and/or third verification-criterion is lower than the respective at least first threshold value or threshold condition.

17. The method according to claim 16, wherein the autonomous parking maneuver is one of a drop-off maneuver or a summon maneuver.

18. The method according to claim 16, comprising determining the distance between the user and the vehicle based on an actual position of the user and the vehicle using Global Positioning System (GPS) data.

19. The method according to claim 16, comprising determining the distance between the user and the vehicle based on key-fob ranging or by using on-board sensors of the vehicle.

20. The method according to claim 16, comprising determining the direction of movement between the user and the vehicle based on continuously monitored position data of the user and the vehicle.

21. The method according to claim 16, comprising monitoring the traffic and/or parking situation using traffic data, Global Positioning System (GPS) data, and/or data measured with on-board-sensors of the vehicle.

22. The method according to claim 21, comprising wirelessly transmitting the user-initiated vehicle-operation command from an electronic handheld user device to a control unit of the vehicle.

23. The method according to claim 22, wherein the electronic handheld user device is a smartphone.

24. The method according to claim 21, wirelessly transmitting the user-initiated vehicle-operation command from a wireless key to a control unit of the vehicle.

25. The method according to claim 21, wherein the user-initiated vehicle-operation command comprises a manual opening attempt of a vehicle door or vehicle trunk by the user.

26. The method according to claim 16, wherein the user-initiated vehicle-operation command comprises to a movement sequence of the user indicating an intention of the user to cancel/stop the autonomous driving or parking operation, wherein the movement sequence is determined based on monitored position data of the user and the vehicle or based on data detected with on-board sensors of the vehicle.

27. The method according to claim 16, comprising stopping the vehicle with a smooth braking procedure when the cancellation or stop command of the autonomous driving or parking operation is accepted.

28. The method according to claim 27, wherein in a case that the cancellation or stop command of the autonomous driving or parking operation is accepted, it is evaluated whether:
the vehicle is immediately stopped, or
the vehicle is stopped at a next possible location.

29. Method according to claim 27, wherein after the vehicle is stopped, the vehicle waits for pre-defined time-period to enable vehicle access for the user, and wherein in case that the user does not enter the vehicle within said pre-defined time-period, the vehicle continues the autonomous driving or parking operation.

30. A system for controlling a user-initiated vehicle-operation command, the user of the vehicle being located external to the vehicle during an autonomous driving or parking operation of the vehicle, the system comprising:
a parking or driving unit configured to perform the autonomous driving or parking operation,
a control unit positioned in vehicle, wherein the control unit is configured to:
receive a cancellation or stop command of the autonomous driving or parking operation;
verify the cancellation or stop command based on a first, a second and/or a third verification-criterion, wherein:
the first verification-criterion includes an actual distance between the user and the vehicle,
the second verification-criterion includes a direction of movement of the user relative to the vehicle, and
the third verification-criterion includes a traffic and/or parking situation in a vicinity of the vehicle,
wherein, for each of the first, second, and/or third verification-criteria, at least a first threshold value or threshold condition is pre-defined, and
wherein the verification is performed by comparing a measured or otherwise determined value or condition corresponding to the first, second, and/or third verification-criterion with the respective at least first threshold value or threshold condition;
deny the cancellation or stop command of the autonomous driving or parking operation when the measured or otherwise determined value or condition corresponding to the first, second, and/or third verification-criterion exceeds the respective at least first threshold value or threshold condition; and
accept the cancellation or stop command of the autonomous driving or parking operation when the measured or otherwise determined value or condition corresponding to the first, second, and/or third verification-criterion is lower than the respective at least first threshold value or threshold condition,
wherein the parking or driving unit and the control unit are configured to interact with each other in terms of exchanging electronic signals and data.

31. A vehicle equipped with a system according to claim 30, wherein the vehicle comprises a Global Positioning System (GPS) system and/or at least one on-board sensor.
